(19) United States
(12) Patent Application Publication
(10) Pub. No.: US 2024/0427257 A1
(43) Pub. Date: Dec. 26, 2024

(54) PIGMENT-CONTAINING POLYESTER RESIN PARTICLES, PRODUCTION METHOD OF PIGMENT-CONTAINING POLYESTER RESIN PARTICLES, MANUFACTURING METHOD OF ELECTROSTATIC CHARGE IMAGE DEVELOPING TONER, ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Yuya KATO, Kanagawa (JP); Takahiro YAMASHITA, Kanagawa (JP); Takahisa TATEKAWA, Kanagawa (JP)

(73) Assignee: FUJIFILM Business Innovation Corp., Tokyo (JP)

(21) Appl. No.: 18/679,483

(22) Filed: May 31, 2024

(30) Foreign Application Priority Data
Jun. 22, 2023 (JP) 2023-102713

(51) Int. Cl. G03G 9/08

(52) U.S. Cl. CPC G03G 9/0819; G03G 9/0804; G03G 9/081; G03G 9/0821

(57) ABSTRACT

Pigment-containing polyester resin particles contains a polyester resin and a pigment, in which the pigment is not exposed on a surface of the pigment-containing polyester resin particles and is not inscribed in a contour of the pigment-containing polyester resin particles.

### CROSS-REFERENCE TO RELATED APPLICATIONS

This application is based on and claims priority under 35 USC 119 from Japanese Patent Application No. 2023-102713 filed Jun. 22, 2023.

### BACKGROUND

### (i) Technical Field

The present disclosure relates to pigment-containing polyester resin particles, a production method of pigment-containing polyester resin particles, an electrostatic charge image developing toner, an electrostatic charge image developer, a toner cartridge, a process cartridge, an image forming apparatus, and an image forming method.

### (ii) Related Art

JP2013-073086A discloses a color toner for electrostatic charge image development, containing coloring resin particles which contains at least a binder resin, a colorant, an antistatic agent, and a release agent, and an external additive, in which the colorant is a resin-coated pigment that a surface of the pigment is coated with a resin and an average primary particle size is 30 to 300 nm, and a tetrahydrofuran-insoluble fraction of the coating resin in the resin-coated pigment is 80% to 100% by mass.

JP2007-534810A discloses a method for producing an aqueous dispersion of a polymer-encapsulated pigment, the method including (a) preparing an aqueous pigment dispersion containing an organic pigment P, a surfactant T, and water; (b) preparing a monomer microemulsion in water, that is stabilized by a hydrophobic organic compound having water solubility of 5×10⁻⁵ g/l or less at 20° C., and consists of a polymerizable monomer M and the surfactant T; (c) combining the aqueous pigment dispersion from (a) and the monomer microemulsion from (b) to be homogenized to generate a pigment-containing monomer microemulsion; and (d) polymerizing the pigment-containing monomer microemulsion from (c) in the presence of a polymerization initiator and/or by heat, with encapsulating the pigment in a polymer to be formed.

### SUMMARY

Aspects of non-limiting embodiments of the present disclosure relate to pigment-containing polyester resin particles that include a small amount of coarse particles. Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following aspects.

According to an aspect of the present disclosure, there is provided pigment-containing polyester resin particles containing a polyester resin; and a pigment, in which the pigment is not exposed on a surface of the pigment-containing polyester resin particles and is not inscribed in a contour of the pigment-containing polyester resin particles.

### BRIEF DESCRIPTION OF THE DRAWINGS

Exemplary embodiment(s) of the present invention will be described in detail based on the following figures, wherein:

FIG. 1 is a view schematically showing the configuration of the image forming apparatus according to the present exemplary embodiment;

FIG. 2 is a view schematically showing the configuration of the process cartridge according to the present exemplary embodiment; and

FIGS. 3A and 3B are schematic views showing an image formed for evaluating an image quality in Examples.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit value or lower limit value of a numerical range may be replaced with the upper limit value or lower limit value of another numerical range described in stages. Furthermore, in the present disclosure, the upper limit or lower limit of a numerical range may be replaced with values described in examples.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, “(meth)acrylic” is an expression including both acrylic and methacrylic, and “(meth)acrylate” is an expression including both acrylate and methacrylate.

In the present disclosure, a “toner” refers to an “electrostatic charge image developing toner”, a “developer” refers to an “electrostatic charge image developer”, and a “carrier” refers to an “electrostatic charge image developing carrier”.

In the present disclosure, a method of manufacturing toner particles by aggregating and coalescing material particles in a dispersion medium is referred to as an emulsion aggregation (EA) method.

### Pigment-Containing Polyester Resin Particles

Pigment-containing polyester resin particles according to the present exemplary embodiment contains a polyester resin and a pigment, in which the pigment is not exposed on a surface of the pigment-containing polyester resin particles and is not inscribed in a contour of the pigment-containing polyester resin particles.

That is, in the pigment-containing polyester resin particles, the entire periphery of the pigment is coated with the polyester resin.

Therefore, in the pigment-containing polyester resin particles according to the present exemplary embodiment, since aggregation of the pigments is suppressed, the coarse particles are few.

A state of the pigment contained in the pigment-containing polyester resin particles is confirmed by the following method.

The pigment-containing polyester resin particles are mixed with an epoxy resin to embed the particles, and the epoxy resin is solidified. In a case where the pigment-containing polyester resin particles are in a form of a dispersion, the dispersion is dried to extract the pigment-containing polyester resin particles.

The solidified substance is cut with an ultramicrotome device (UltracutUCT, Leica Microsystems), thereby producing a thin sample having a thickness of 100 nm. A cross section of the thin sample is observed with a field emission scanning electron microscope (FE-SEM, model number: S-4800, Hitachi High-Tech Corporation.) at a magnification of 10,000 times to obtain an SEM image. The SEM image is imported into image analysis software ImageJ bundled with 32-bit Java 1.6.0_24ver (Java is a registered trademark), noise in the image is removed by Despeckle processing of a process menu, and then the image is analyzed under a condition of a brightness threshold value of 50% to perform binarization, thereby extracting a contour of pigment particles existing inside the pigment-containing polyester resin particles. Whether the pigment particles are primary particles or secondary particles is not a problem. All resin particles and pigment particles in one field of view are observed, and the presence or absence of the pigment particles protruding from an outer edge of the resin particles (that is, the exposure) and the presence or absence of the pigment particles in contact with the outer edge of the resin particles (that is, the inscription) are confirmed. The same operation is repeated until at least 100 or more resin particles are observed.

In a case where the total number of resin particles that the pigment particles are protruding from the outer edge of the resin particles and resin particles that the pigment particles are in contact with the outer edge of the resin particles is 5% or less of the total number of the observed resin particles, it is determined that the pigment is not exposed on the surface of the pigment-containing polyester resin particles and is not inscribed in the contour of the pigment-containing polyester resin particles.

In the related art, a polyester resin and a styrene acrylic resin have been generally used as a binder resin of a toner. From the viewpoint of low-temperature fixability of the toner, the polyester resin is generally more excellent than the styrene acrylic resin.

In a case where the pigment-containing polyester resin particles according to the present exemplary embodiment are used, the polyester resin can be used as a major binder resin of the toner, and a toner having excellent low-temperature fixability can be manufactured.

In addition, in a case where the pigment-containing polyester resin particles according to the present exemplary embodiment are used, large lumps of the pigment are suppressed from being included inside the toner particles, and the toner to be manufactured is less likely to cause image unevenness.

The pigment-containing polyester resin particles according to the present exemplary embodiment have a volume-average particle size of, for example, preferably 50 nm or more and 500 nm or less.

In a case where the volume-average particle size of the pigment-containing polyester resin particles is 50 nm or more, the pigment is less likely to be exposed, and thus the pigment-containing polyester resin particles are less likely to be coarsened. From the viewpoint, the volume-average particle size of the pigment-containing polyester resin particles is, for example, more preferably 80 nm or more and still more preferably 100 nm or more.

In a case where the volume-average particle size of the pigment-containing polyester resin particles is 500 nm or less, the pigment in the pigment-containing polyester resin particles is unlikely to aggregate. From the viewpoint, the volume-average particle size of the pigment-containing polyester resin particles is, for example, more preferably 400 nm or less and still more preferably 300 nm or less.

The volume-average particle size of the pigment-containing polyester resin particles refers to a particle size at which 50% of the particles are accumulated from a small size side in a particle size distribution measured with a laser diffraction-type particle size distribution analyzer (for example, model number: LS13-320, Beckman Coulter, Inc.). The number of particles to be measured is 10,000.

The pigment-containing polyester resin particles according to the present exemplary embodiment have a content of the pigment of, for example, preferably 10% by mass or more and 60% by mass or less.

In a case where the content of the pigment is 10% by mass or more, for example, it is desirable that the pigment-containing polyester resin particles are used as an image forming material. From the viewpoint, the content of the pigment is, for example, more preferably 12% by mass or more and still more preferably 15% by mass or more.

In a case where the content of the pigment is 60% by mass or less, the pigment is less likely to be exposed, and thus the pigment-containing polyester resin particles are less likely to be coarsened. From the viewpoint, the content of the pigment is, for example, more preferably 55% by mass or less and still more preferably 50% by mass or less.

In the pigment-containing polyester resin particles according to the present exemplary embodiment, an average size of the pigment is, for example, preferably 10 nm or more and 400 nm or less.

In a case where the average size of the pigment is 10 nm or more, the pigment is unlikely to aggregate. From the viewpoint, the average size of the pigment is, for example, more preferably 15 nm or more and still more preferably 20 nm or more.

In a case where the average size of the pigment is 400 nm or less, the pigment is less likely to be exposed, and thus the pigment-containing polyester resin particles are less likely to be coarsened. From the viewpoint, the average size of the pigment is, for example, more preferably 300 nm or less and still more preferably 200 nm or less.

The average size of the pigment contained in the pigment-containing polyester resin particles is obtained by the following method.

The pigment-containing polyester resin particles are mixed with an epoxy resin to embed the particles, and the epoxy resin is solidified. In a case where the pigment-containing polyester resin particles are in a form of a dispersion, the dispersion is dried to extract the pigment-containing polyester resin particles.

The solidified substance is cut with an ultramicrotome device (UltracutUCT, Leica Microsystems), thereby producing a thin sample having a thickness of 100 nm. A cross section of the thin sample is observed with a field emission scanning electron microscope (FE-SEM, model number: S-4800, Hitachi High-Tech Corporation.) at a magnification of 10,000 times to obtain an SEM image. The SEM image is imported into image analysis software ImageJ bundled with 32-bit Java 1.6.0_24ver (Java is a registered trademark), noise in the image is removed by Despeckle processing of a process menu, and then the image is analyzed under a condition of a brightness threshold value of 50% to perform binarization, thereby extracting a contour of pigment particles existing inside the pigment-containing polyester resin particles. Whether the pigment particles are primary particles or secondary particles is not a problem. An equivalent circle diameter of the contour of each of all pigment particles in one field of view is measured. The same operation is repeated until at least 100 or more pigment particles are measured. An arithmetic mean of the measured equivalent circle diameters is defined as the average size of the pigment.

### Pigment

Examples of the pigment include organic pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and inorganic pigments such as a titanium compound and silica.

One kind of pigment may be used alone, or two or more kinds of pigments may be used in combination.

As the pigment, a pigment that is surface-treated may be used as necessary.

### Polyester Resin

Examples of the polyester resin include an amorphous polyester resin and a crystalline polyester resin. As the polyester resin, only an amorphous polyester resin may be used, only a crystalline polyester resin may be used, or an amorphous polyester resin and a crystalline polyester resin may be used in combination. As the polyester resin, for example, an amorphous polyester resin is suitable.

An acid value of the polyester resin is, for example, preferably 1 mgKOH/g or more and 50 mgKOH/g or less.

In a case where the acid value of the polyester resin is 1 mgKOH/g or more, a resin composition in the production of the pigment-containing polyester resin particles does not have too low viscosity, and the pigment is likely to be incorporated into the pigment-containing polyester resin particles. From the viewpoint, the acid value of the polyester resin is, for example, more preferably 5 mgKOH or more and still more preferably 10 mgKOH or more.

In a case where the acid value of the polyester resin is 50 mgKOH/g or less, a resin composition in the production of the pigment-containing polyester resin particles does not have too high viscosity, and the pigment is likely to be incorporated into the pigment-containing polyester resin particles. From the viewpoint, the acid value of the polyester resin is, for example, more preferably 45 mgKOH or less and still more preferably 40 mgKOH or less.

The acid value of the polyester resin is determined by a neutralization titration method specified in JIS K 0070-1992 using an appropriate amount of the polyester resin as a sample.

### Amorphous Polyester Resin

As the amorphous polyester resin, a commercially available product may be used, or a synthetic resin may be used.

Examples of the amorphous polyester resin include a polycondensate of a polyvalent carboxylic acid and a polyhydric alcohol.

Examples of the polyvalent carboxylic acid that is a polymerization component of the amorphous polyester resin include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among the above, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol that is a polymerization component of the amorphous polyester resin include aliphatic diols (for example, ethylene glycol, diethylene glycol, triethylene glycol, propylene glycol, neopentyl glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the above, for example, aliphatic diols are preferable as the polyhydric alcohol.

As the polyhydric alcohol that is a polymerization component of the amorphous polyester resin, a polyhydric alcohol having a valency of 3 or more and a crosslinked structure or a branched structure may be used in combination with a diol. Examples of the polyhydric alcohol having a valency of 3 or more include glycerin, trimethylolpropane, and pentaerythritol.

One kind of polyhydric alcohol may be used alone, or two or more kinds of polyhydric alcohols may be used in combination.

A glass transition temperature (Tg) of the amorphous polyester resin is, for example, preferably 50° C. or higher and 75° C. or lower, more preferably 50° C. or higher and 70° C. or lower, and still more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

A weight-average molecular weight (Mw) of the amorphous polyester resin is, for example, preferably 5,000 or more and 1,000,000 or less, and more preferably 7,000 or more and 500,000 or less.

A number-average molecular weight (Mn) of the amorphous polyester resin is, for example, preferably 2,000 or more and 100,000 or less.

A molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC⋅HLC-8120GPC manufactured by Tosoh Corporation as a measurement device, TSKgel Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

The amorphous polyester resin is obtained by a known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the copolymerization reaction, for example, the monomer with poor compatibility may be condensed in advance with an acid or an alcohol that is to be polycondensed with the monomer, and then polycondensed with the major component.

### Crystalline Polyester Resin

As the crystalline polyester resin, a commercially available product may be used, or a synthetic resin may be used.

Examples of the crystalline polyester resin include a polycondensate of polyvalent carboxylic acid and polyhydric alcohol. Since the crystalline polyester resin easily forms a crystal structure, the crystalline polyester resin is, for example, preferably a polycondensate formed of a linear aliphatic polymerizable monomer than a polycondensate formed of a polymerizable monomer having an aromatic ring.

Examples of the polyvalent carboxylic acid that is a polymerization component of the crystalline polyester resin include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol that is a polymerization component of the crystalline polyester resin include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol.

As the polyhydric alcohol that is a polymerization component of the crystalline polyester resin, an alcohol having a valency of 3 or more and having a crosslinked structure or a branched structure may be used in combination with a diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

A melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

A weight-average molecular weight (Mw) of the crystalline polyester resin is, for example, preferably 6,000 or more and 35,000 or less.

The crystalline polyester resin can be obtained by a known manufacturing method, for example, same as the amorphous polyester resin.

### Production Method of Pigment-Containing Polyester Resin Particles

For example, the pigment-containing polyester resin particles are preferably produced in a form of a dispersion containing the particles. That is, a production step of the pigment-containing polyester resin particles is, for example, preferably a step of producing a dispersion of the pigment-containing polyester resin particles.

From the viewpoint of containing a sufficient amount of the pigment in the toner particles, a concentration of solid contents of the dispersion of the pigment-containing polyester resin particles is, for example, preferably 10% by mass or more, more preferably 15% by mass or more, and still more preferably 20% by mass or more.

From the viewpoint of dispersibility of the particles, the concentration of solid contents of the dispersion of the pigment-containing polyester resin particles is, for example, preferably 40% by mass or less, more preferably 35% by mass or less, and still more preferably 30% by mass or less.

For example, the pigment-containing polyester resin particles are preferably produced by “solventless emulsification” or “solvent emulsification” described below. The “solventless emulsification” and “solvent emulsification” are carried out to produce the dispersion of the pigment-containing polyester resin particles.

In the “solventless emulsification” or the “solvent emulsification”, by controlling operation conditions of a device and/or an amount of materials used, the volume-average particle size of the pigment-containing polyester resin particles, the content of the pigment, the average size of the pigment, and the like can be controlled, for example, within a preferable range while the entire periphery of the pigment is coated with the polyester resin.

### Solventless Emulsification

The solventless emulsification is a method of producing the resin particle dispersion without using an organic solvent.

Specifically, the solventless emulsification includes mixing a polyester resin, a pigment, a basic compound, and a surfactant by applying heat and a shear force to obtain a mixture in which the pigment is dispersed in a melted polyester resin (melting step); and adding an aqueous medium to the mixture while applying a shear force to the mixture to perform emulsification (emulsification step).

In the solventless emulsification, for example, it is preferable that the melting step and the emulsification step are carried out using a kneading extruder. The kneading extruder is a device that applies heat and a shear force to materials to be treated while continuously transporting the materials to be treated. In general, a structure of the kneading extruder is substantially divided into a material inlet, a barrel, and a die in this order from the upstream to the downstream. A screw is provided inside the barrel. A heater for heating the inside of the barrel is provided around the barrel. The screw may be uniaxial or biaxial, and for example, a biaxial screw is preferable.

### Melting Step

The melting step is a step of mixing a polyester resin, a pigment, a basic compound, and a surfactant by applying heat and a shear force to obtain a mixture in which the pigment is dispersed in a melted polyester resin.

As the basic compound, for example, sodium hydroxide or potassium hydroxide is suitable. From the viewpoint of kneading uniformity, for example, it is preferable that sodium hydroxide or potassium hydroxide is used in a form of an aqueous solution (that is, sodium hydroxide aqueous solution or potassium hydroxide aqueous solution).

An amount of the basic compound used is an amount capable of achieving emulsification and dispersion of the mixture. Specifically, the amount of the basic compound used is, for example, preferably an amount at which a neutralization rate according to the following expression (1) is 20% or more and 60% or less.

Neutralization rate (%)=mb×n×56.1÷Mwb÷AV×1000 Expression (1):
where, mb is the amount (g) of the basic compound used per 1 g of the polyester resin,
n is a valence of the basic compound,
Mwb is a molecular weight of the basic compound, and
AV is an acid value (mgKOH/g) of the polyester resin.

The surfactant may be any of an anionic surfactant, a cationic surfactant, or a nonionic surfactant. Examples thereof include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. One kind of surfactant may be used alone, or two or more kinds of surfactants may be used in combination. The nonionic surfactant may be used in combination with the anionic surfactant or the cationic surfactant.

An amount of the surfactant used is an amount at which the emulsified particles can maintain the dispersion.

### Emulsification Step

The emulsification step is a step of adding an aqueous medium to the mixture in which the pigment is dispersed in the melted polyester resin while applying a shear force to the mixture to perform emulsification.

As the aqueous medium, for example, water having a reduced ion content, such as distilled water and deionized water, is preferable. For example, it is preferable that the aqueous medium is used by adjusting a temperature to a range of a temperature inside the barrel of the kneading extruder ±5° C.

In the melting step, the temperature inside the barrel of the kneading extruder is, for example, preferably 80° C. or higher and 100° C. or lower, more preferably 85° C. or higher and 97° C. or lower, and still more preferably 90° C. or higher and 95° C. or lower.

In the emulsification step, the temperature inside the barrel of the kneading extruder is, for example, preferably 80° C. or higher and 100° C. or lower, more preferably 85° C. or higher and 97° C. or lower, and still more preferably 90° C. or higher and 95° C. or lower.

### Solvent Emulsification

Specifically, the solvent emulsification includes mixing a polyester resin, a pigment, and an organic solvent by applying heat and a shear force to obtain a mixture in which the pigment is dispersed in a dissolved polyester resin (dissolving step); and adding a basic compound to the mixture, and adding an aqueous medium to the mixture while applying a shear force to the mixture to perform emulsification (emulsification step).

In the solvent emulsification, for example, it is preferable that the dissolving step and the emulsification step are carried out in an agitated vessel provided with an agitation unit and a heating and cooling unit. The agitation unit is, for example, preferably an agitation unit including a rotation shift and an agitation blade. The heating and cooling unit is, for example, a unit that applies and/or absorbs heat from a wall surface of the agitated vessel.

### Dissolving Step

The dissolving step is a step of mixing a polyester resin, a pigment, and an organic solvent by applying heat and a shear force to obtain a mixture in which the pigment is dispersed in a dissolved polyester resin.

Examples of the organic solvent in which the polyester resin is soluble include ethyl acetate, isopropanol, 2-butanol, and a mixed solvent thereof. Among the above, for example, an organic solvent or a mixed solvent having a boiling point of 60° C. or higher and lower than 100° C. is preferable.

### Emulsification Step

The emulsification step is a step of adding a basic compound to the mixture; and adding an aqueous medium to the mixture while applying a shear force to the mixture to emulsify and disperse the mixture in the aqueous medium in a particulate form.

As the basic compound, for example, aqueous ammonia is suitable.

An amount of the basic compound used is an amount capable of achieving emulsification and dispersion of the mixture. Specifically, the amount of the basic compound used is, for example, preferably an amount at which a neutralization rate according to the following expression (1) is 70% or more and 100% or less.

Neutralization rate (%)=mb×n×56.1÷Mwb÷AV×1000 Expression (1):
where, mb is the amount (g) of the basic compound used per 1 g of the polyester resin,
n is a valence of the basic compound,
Mwb is a molecular weight of the basic compound, and
AV is an acid value (mgKOH/g) of the polyester resin.

As the aqueous medium, for example, water having a reduced ion content, such as distilled water and deionized water, is preferable. For example, it is preferable that the aqueous medium is used by adjusting a temperature to a range of 35° C. or higher and 100° C. or lower (for example, preferably 35° C. or higher and 55° C. or lower).

In the dissolving step, a temperature of the materials to be treated, contained in the agitated vessel, is, for example, preferably 20° C. or higher and 50° C. or lower, more preferably 23° C. or higher and 45° C. or lower, and still more preferably 25° C. or higher and 40° C. or lower.

In the emulsification step, a temperature of the materials to be treated, contained in the agitated vessel, is, for example, preferably 20° C. or higher and 50° C. or lower, more preferably 23° C. or higher and 45° C. or lower, and still more preferably 25° C. or higher and 40° C. or lower.

The method of adding the aqueous medium in the emulsification step is, for example, preferably dropwise addition.

After the addition of the aqueous medium is completed, for example, it is preferable to reduce a pressure inside the agitated vessel and/or to bubble the emulsion to remove the organic solvent. Thereafter, in order to improve dispersion stability of the particles, a surfactant may be added. Examples of the surfactant include the anionic surfactant, the cationic surfactant, and the nonionic surfactant described above.

### Manufacturing Method of Electrostatic Charge Image Developing Toner

The manufacturing method of the toner according to the present exemplary embodiment is a manufacturing method of a toner including manufacturing toner particles by the EA method.

In the manufacturing method of the toner according to the present exemplary embodiment, at least pigment-containing polyester resin particles are used as material particles.

Therefore, the manufacturing method of the toner according to the present exemplary embodiment includes obtaining toner particles by aggregating and coalescing material particles containing the pigment-containing polyester resin particles in a dispersion medium.

Specifically, the manufacturing method of the toner according to the present exemplary embodiment includes aggregating the pigment-containing polyester resin particles according to the present exemplary embodiment in a dispersion containing the pigment-containing polyester resin particles to form aggregated particles; and heating the dispersion containing the aggregated particles for coalescing the aggregated particles together to form toner particles.

Hereinafter, each step and material of the EA method in the present exemplary embodiment will be described in detail.

### Aggregation Step (First Aggregation Step)

The aggregation step is a step of aggregating the material particles in a dispersion containing the material particles to form aggregated particles.

In a case where the manufacturing method of the toner according to the present exemplary embodiment includes a second aggregation step (step of forming a shell) described later, the above-described aggregation step is referred to as “first aggregation step”. The first aggregation step is a step of forming a core in a toner having a core/shell structure.

The dispersion to be subjected to the aggregation step contains at least the pigment-containing polyester resin particles. For example, it is preferable that the dispersion to be subjected to the aggregation step contains binder resin particles and release agent particles.

For example, the dispersion to be subjected to the aggregation step is produced by preparing a dispersion of the pigment-containing polyester resin particles, a dispersion of the binder resin particles, and a dispersion of the release agent particles, and then mixing these particle dispersions. The order of mixing these particle dispersions is not limited.

Hereinafter, common features of the dispersion of the binder resin particles and the dispersion of the release agent particles will be collectively referred to as “particle dispersion”.

An example of an exemplary embodiment of the particle dispersion is a dispersion obtained by dispersing a material in a dispersion medium in a particulate form, using a surfactant.

As the dispersion medium of the particle dispersion, for example, an aqueous medium is preferable. Examples of the aqueous medium include water and alcohol. As the water, for example, water having a reduced ion content, such as distilled water and deionized water, is preferable. One kind of aqueous medium may be used alone, or two or more kinds of aqueous media may be used in combination.

The surfactant that disperses the material in the dispersion medium may be any of an anionic surfactant, a cationic surfactant, or a nonionic surfactant. Examples thereof include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. One kind of surfactant may be used alone, or two or more kinds of surfactants may be used in combination. The nonionic surfactant may be used in combination with the anionic surfactant or the cationic surfactant.

Examples of the method of dispersing the material in the dispersion medium in a particulate form include known dispersion methods such as a rotating shear type homogenizer, a ball mill having a medium, a sand mill, and a dyno mill.

Examples of the method of dispersing the resin in the dispersion medium in a particulate form include a phase-transfer emulsification method. An example of the phase-transfer emulsification method is a method of dissolving the resin in a hydrophobic organic solvent in which the resin is soluble, adding the basic compound to an organic continuous phase (O phase), and then adding the aqueous medium (W phase) to perform a phase transition from W/O to O/W, thereby dispersing the resin in the aqueous medium in a particulate form.

A volume-average particle size of the particles dispersed in the particle dispersion is, for example, preferably 30 nm or more and 300 nm or less, more preferably 50 nm or more and 250 nm or less, and still more preferably 80 nm or more and 200 nm or less.

The volume-average particle size of the particles in the particle dispersion refers to a particle size at which 50% of the particles are accumulated from a small size side in a particle size distribution measured with a laser diffraction-type particle size distribution analyzer (for example, model number: LS13-320, Beckman Coulter, Inc.). The number of particles to be measured is 10,000.

A content of the particles contained in the particle dispersion is, for example, preferably 5% by mass or more and 50% by mass or less, more preferably 10% by mass or more and 40% by mass or less, and still more preferably 15% by mass or more and 30% by mass or less.

Hereinafter, materials constituting the particles in the dispersion of the binder resin particles and the dispersion of the release agent particles will be described.

### Binder Resin

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

As the binder resin, for example, a polyester resin is suitable. Examples of the polyester resin include an amorphous polyester resin and a crystalline polyester resin. As the polyester resin, only an amorphous polyester resin may be used, only a crystalline polyester resin may be used, or an amorphous polyester resin and a crystalline polyester resin may be used in combination.

In a case where the amorphous polyester resin is used in the production of the pigment-containing polyester resin particles, for example, it is preferable that an amorphous polyester resin having the same form as the amorphous polyester resin is contained in the binder resin.

In a case where the crystalline polyester resin is used in the production of the pigment-containing polyester resin particles, for example, it is preferable that a crystalline polyester resin having the same form as the crystalline polyester resin is contained in the binder resin.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature of the release agent is determined from a DSC curve obtained by differential scanning calorimetry (DSC) by “peak melting temperature” described in the method for determining the melting temperature in JIS K7121: 1987, “Testing methods for transition temperatures of plastics”.

Hereinafter, the dispersion obtained by mixing a plurality of kinds of particle dispersions is referred to as “mixed dispersion”.

A mass ratio of the particles contained in the mixed dispersion is, for example, preferably in the following range.

A mass ratio of the binder resin particles and the pigment-containing polyester resin particles as binder resin particles: pigment-containing polyester resin particles is, for example, preferably 100:1 to 100:100, more preferably 100:2 to 100:60, and still more preferably 100:5 to 100:40.

A mass ratio of the binder resin particles and the release agent particles as binder resin particles: release agent particles is, for example, preferably 100:1 to 100:40, more preferably 100:2 to 100:30, and still more preferably 100:5 to 100:20.

For example, it is preferable to adjust a pH of the mixed dispersion to a range of 3 or more and 4 or less after the mixing of the plurality of kinds of particle dispersions. Examples of a means of adjusting the pH of the mixed dispersion include adding an acidic aqueous solution such as a nitric acid aqueous solution, a hydrochloric acid aqueous solution, and a sulfuric acid aqueous solution.

The aggregation step includes, for example, adding an aggregating agent to the mixed dispersion while agitating the mixed dispersion, and heating the mixed dispersion while agitating the mixed dispersion liquid after adding the aggregating agent to the mixed dispersion to raise a temperature of the mixed dispersion.

Examples of the aggregating agent include a surfactant having polarity opposite to the polarity of the surfactant contained in the mixed dispersion, an inorganic metal salt, and a metal complex having a valency of 2 or more. One kind of aggregating agent may be used alone, or two or more kinds of aggregating agents may be used in combination.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the aggregating agent, for example, a metal salt compound having a valency of 2 or more is preferable, a trivalent metal salt compound is more preferable, and a trivalent inorganic aluminum salt compound is still more preferable. Examples of the trivalent inorganic aluminum salt compound include aluminum chloride, aluminum sulfate, polyaluminum chloride, and polyaluminum hydroxide.

An amount of the aggregating agent added is not limited. In a case where the trivalent metal salt compound is used as the aggregating agent, an amount of the trivalent metal salt compound added is, for example, preferably 0.01 parts by mass or more and 10 parts by mass or less, more preferably 0.05 parts by mass or more and 5 parts by mass or less, and still more preferably 0.1 parts by mass or more and 3 parts by mass or less with respect to 100 parts by mass of the binder resin.

A reaching temperature of the mixed dispersion in a case of heating the mixed dispersion is, for example, preferably a temperature based on the glass transition temperature (Tg) of the binder resin particles, for example, (Tg−30° C.) or higher and (Tg° C.) or lower with regard to the binder resin particles.

In a case where the mixed dispersion contains a plurality of kinds of binder resin particles having different Tg's, the lowest temperature among the Tg's is defined as the Tg in the aggregation step.

### Second Aggregation Step

The second aggregation step is a step provided for the purpose of manufacturing a toner having a core/shell structure, and is a step provided after the first aggregation step. The second aggregation step is a step of forming a shell.

The second aggregation step is a step of mixing the dispersion containing the aggregated particles with a dispersion containing resin particles that are to be a shell to aggregate the resin particles to be a shell on a surface of the aggregated particles, thereby forming second aggregated particles.

As the dispersion containing the resin particles to be a shell, for example, at least one selected from a binder resin particle dispersion for forming a core is suitable; a polyester resin particle dispersion is more suitable; and an amorphous polyester resin particle dispersion is still more suitable.

The second aggregation step includes, for example, adding the dispersion containing the resin particles to be a shell to the dispersion containing the aggregated particles while agitating the dispersion containing the aggregated particles, and heating the dispersion containing the aggregated particles, after adding the dispersion containing the resin particles to be a shell, while agitating the dispersion.

A reaching temperature of the dispersion containing the aggregated particles in a case of heating the dispersion containing the aggregated particles is, for example, preferably a temperature based on the glass transition temperature (Tg) of the resin particles to be a shell, for example, (Tg−30° C.) or higher and (Tg−10)° C. or lower with regard to the resin particles to be a shell.

After the aggregated particles or the second aggregated particles have grown to a predetermined size, in order to stop the growth of the aggregated particles or the second aggregated particles before the heating in the coalescence step, a chelating agent for the aggregating agent used in the aggregation step may be added to the dispersion containing the aggregated particles or the second aggregated particles.

Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

An amount of the chelating agent added with respect to 100 parts by mass of the binder resin particles is, for example, preferably 0.01 parts by mass or more and 5.0 parts by mass or less, and more preferably 0.1 parts by mass or more and less than 3.0 parts by mass.

After the aggregated particles or the second aggregated particles have grown to a predetermined size, in order to stop the growth of the aggregated particles or the second aggregated particles before the heating in the coalescence step, a pH of the dispersion containing the aggregated particles or the second aggregated particles may be increased.

Examples of a means of increasing the pH of the dispersion containing the aggregated particles or the second aggregated particles include addition of at least one selected from the group consisting of an aqueous solution of an alkali metal hydroxide and an aqueous solution of an alkaline earth metal hydroxide.

A reaching pH of the dispersion containing the aggregated particles or the second aggregated particles is preferably, for example, 8 or more and 10 or less.

### Coalescence Step

The coalescence step is a step of heating the dispersion containing the aggregated particles for coalescing the aggregated particles together to form toner particles.

In a case where the second aggregation step is provided before the coalescence step, the coalescence step is a step of heating the dispersion containing the second aggregated particles for coalescing the second aggregated particles to form toner particles. By passing through the second aggregation step and the coalescence step, toner particles having a core/shell structure can be manufactured.

Aspects to be described below are common to the aggregated particles and the second aggregated particles.

A reaching temperature of the dispersion containing the aggregated particles is, for example, preferably a temperature equal to higher than the glass transition temperature (Tg) of the binder resin, specifically, higher than Tg of the binder resin by 10° C. to 30° C.

In a case where the aggregated particles have a plurality of kinds of binder resins having different Tg's, the lowest temperature among the Tg's is defined as the glass transition temperature in the coalescence step.

After the coalescence step ends, the toner particles in the dispersion are subjected to known washing step, solid-liquid separation step, and drying step, thereby obtaining dry toner particles. As the washing step, from the viewpoint of charging properties, for example, displacement washing may be thoroughly performed using deionized water. As the solid-liquid separation step, from the viewpoint of productivity, for example, suction filtration, pressure filtration, or the like may be performed. As the drying step, from the viewpoint of productivity, for example, freeze drying, flush drying, fluidized drying, vibratory fluidized drying, or the like may be performed.

### Step of Externally Adding External Additive

For example, the manufacturing method of the toner according to the present exemplary embodiment preferably includes a step of externally adding an external additive to the toner particles.

The toner particles and the external additive in a dry state are mixed with each other to perform the external addition of the external additive to the toner particles. The mixing is performed, for example, using a V blender, a Henschel mixer, a Lödige mixer, or the like. Furthermore, coarse particles of the toner may be removed as necessary by using a vibratory sieving machine, a pneumatic sieving machine, or the like.

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surface of the inorganic particles as an external additive may have undergone, for example, a hydrophobic treatment. The hydrophobic treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethyl methacrylate, and melamine resins), a cleaning activator (for example, and a metal salt of a higher fatty acid represented by zinc stearate or fluorine-based polymer particles).

The amount of the external additive externally added with respect to the mass of the toner particles is, for example, preferably 0.01% by mass or more and 5% by mass or less, and more preferably 0.01% by mass or more and 2% by mass or less.

### Electrostatic Charge Image Developing Toner

The toner according to the present exemplary embodiment contains at least toner particles. For example, the toner according to the present exemplary embodiment preferably contains toner particles and an external additive.

The toner according to the present exemplary embodiment contains toner particles containing a polyester resin and a pigment, in which, in the toner particles, a number proportion of a pigment having a maximum Feret diameter of 250 nm or more is 20% by number or less.

The maximum Feret diameter of 250 nm for the pigment inside the toner particles is an index of aggregation, and the “pigment having a maximum Feret diameter of 250 nm or more” refers to undesirable aggregates.

In the toner according to the present exemplary embodiment, since the number proportion of the pigment particles having a maximum Feret diameter of 250 nm or more is 20% by number or less of the total number of the pigment particles, the low-temperature fixability is excellent and the image unevenness is less likely to occur.

The number proportion of the pigment having a maximum Feret diameter of 250 nm or more is, for example, more preferably 15% by number or less, still more preferably 10% by number or less, and most preferably 0% by number.

The maximum Feret diameter of the pigment contained in the toner particles is measured by the following method.

The toner is mixed with and embedded in an epoxy resin, and the epoxy resin is solidified. The solidified substance is cut with an ultramicrotome device (UltracutUCT, Leica Microsystems), thereby producing a thin sample having a thickness of 100 nm. A cross section of the thin sample is observed with a field emission scanning electron microscope (FE-SEM, model number: S-4800, Hitachi High-Tech Corporation.) at a magnification of 10,000 times to obtain an SEM image. The SEM image is imported into image analysis software ImageJ bundled with 32-bit Java 1.6.0_24ver (Java is a registered trademark), noise in the image is removed by Despeckle processing of a process menu, and then the image is analyzed under a condition of a brightness threshold value of 50% to perform binarization, thereby extracting a contour of pigment particles existing inside the toner particles. Whether the pigment particles are primary particles or secondary particles is not a problem. The maximum Feret diameter is measured for the contour of all pigment particles existing inside the toner particles. The same operation is performed on 100 toner particles. The distribution of the maximum Feret diameter is divided in a range of 10 nm or more and 2,000 nm or less at intervals of 50 nm, and the number proportion (% by number) of the pigment having a maximum Feret diameter of 250 nm or more is obtained.

The total content of the polyester resin with respect to the total amount of the toner is, for example, preferably 40% by mass or more and 95% by mass or less, more preferably 50% by mass or more and 90% by mass or less, and still more preferably 60% by mass or more and 85% by mass or less.

In a case where the toner particles contain the crystalline polyester resin, a content of the crystalline polyester resin is, for example, preferably 3% by mass or more and 30% by mass or less, and more preferably 8% by mass or more and 20% by mass or less with respect to the total amount of the binder resin.

In a case where the toner contains the release agent, a content of the release agent is, for example, preferably 1% by mass or more and 20% by mass or less and more preferably 5% by mass or more and 15% by mass or less with respect to the total amount of the toner.

A content of the pigment is, for example, preferably 1% by mass or more and 30% by mass or less and more preferably 3% by mass or more and 15% by mass or less with respect to the total amount of the toner.

The toner particles may be toner particles that have a single-layer structure or toner particles having a so-called core/shell structure that is configured with a core portion (core particle) and a coating layer (shell layer) coating the core portion.

The volume-average particle size (D50v) of the toner particles is, for example, preferably 2 μm or more and 10 μm or less, and more preferably 4 μm or more and 8 μm or less.

The average particle size of the toner particles is measured using COULTER MULTISIZER II (manufactured by Beckman Coulter, Inc.) and using ISOTON-II (manufactured by Beckman Coulter, Inc.) as an electrolytic solution. A measurement sample in an amount of 0.5 mg or more and 50 mg or less is added to 2 ml of a 5% by mass aqueous solution of a surfactant (for example, preferably sodium alkylbenzene sulfonate), and the mixture is added to 100 ml or more and 150 ml or less of the electrolytic solution. The electrolytic solution in which the sample is added is subjected to a dispersion treatment for 1 minute with an ultrasonic disperser, and the particle size of the particles is measured in a range of 2 μm or more and 60 μm or less using COULTER MULTISIZER II with an aperture having an aperture size of 100 μm. The number of particles to be measured is 50,000. A volume distribution or a number distribution is drawn from a small size side based on the measured particle size distribution, and a particle size having a cumulative percentage of 50% is defined as the volume-average particle size D50v or the number-average particle size D50p.

The average circularity of the toner particles is, for example, preferably 0.94 or more and 1.00 or less, and more preferably 0.95 or more and 0.98 or less.

The average circularity of the toner particles is (equivalent circular perimeter)/(perimeter)=Average of (perimeter of circle having the same area as projected area of particles)/(perimeter of projected particle image).

As a particle image measuring device, a flow-type particle image analyzer (FPIA-3000 manufactured by Sysmex Corporation) is used. The number of toner particles to be measured is 3,500. In a case where a toner contains external additives, the toner is dispersed in water containing a surfactant, the dispersion is treated with ultrasonic waves such that the external additives are removed, and the toner particles are obtained.

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

For example, it is preferable that the surface of the inorganic particles as an external additive is subjected to a hydrophobic treatment. The hydrophobic treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination. The amount of the hydrophobic agent is, for example, 1 part by mass or more and 10 parts by mass or less with respect to 100 parts by mass of the inorganic particles.

Examples of the external additive also include resin particles (resin particles such as polystyrene, polymethyl methacrylate, and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 5% by mass or less, and more preferably 0.01% by mass or more and 2% by mass or less.

### Electrostatic Charge Image Developer

The electrostatic charge image developer according to the present exemplary embodiment contains at least the toner according to the present exemplary embodiment.

The electrostatic charge image developer according to the present exemplary embodiment may be a one-component developer that contains only the toner according to the present exemplary embodiment or a two-component developer which is obtained by mixing the toner and a carrier together.

The carrier is not particularly limited, and examples thereof include known carriers. Examples of the carrier include a coated carrier obtained by coating the surface of a core material consisting of magnetic powder with a resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating the surface of a core material, that is particles configuring the carrier, with a resin.

Examples of the magnetic powder include magnetic metals such as iron, nickel, and cobalt; and magnetic oxides such as ferrite and magnetite.

Examples of the coating resin and matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid ester copolymer, a straight silicone resin configured with an organosiloxane bond, a product obtained by modifying the straight silicone resin, a fluororesin, polyester, polycarbonate, a phenol resin, and an epoxy resin. The coating resin and the matrix resin may contain other additives such as conductive particles. Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a resin, for example, by a coating method using a solution for forming a coating layer obtained by dissolving the coating resin and various additives (used as necessary) in an appropriate solvent, and the like. The solvent is not particularly limited, and may be selected in consideration of the type of the resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and then removing solvents.

The mixing ratio (mass ratio) between the toner and the carrier, represented by toner: carrier, in the two-component developer is, for example, preferably 1:100 to 30:100, and more preferably 3:100 to 20:100.

### Image Forming Apparatus and Image Forming Method

The image forming apparatus and image forming method according to the present exemplary embodiment will be described.

The image forming apparatus according to the present exemplary embodiment includes an image holder, a charging unit that charges the surface of the image holder, an electrostatic charge image forming unit that forms an electrostatic charge image on the charged surface of the image holder, a developing unit that contains an electrostatic charge image developer and develops the electrostatic charge image formed on the surface of the image holder as a toner image using the electrostatic charge image developer, a transfer unit that transfers the toner image formed on the surface of the image holder to the surface of a recording medium, and a fixing unit that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed which has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning unit that cleans the surface of the image holder before charging after the transfer of the toner image; and an apparatus including a charge erasing unit that erases charge by irradiating the surface of the image holder with charge erasing light before charging after the transfer of the toner image.

In the case where the image forming apparatus according to the present exemplary embodiment is the intermediate transfer-type apparatus, as the transfer unit, for example, a configuration is adopted which has an intermediate transfer member with surface on which the toner image will be transferred, a primary transfer unit that performs primary transfer to transfer the toner image formed on the surface of the image holder to the surface of the intermediate transfer member, and a secondary transfer unit that performs secondary transfer to transfer the toner image transferred to the surface of the intermediate transfer member to the surface of a recording medium.

In the image forming apparatus according to the present exemplary embodiment, for example, a portion including the developing unit may be a cartridge structure (process cartridge) detachable from the image forming apparatus. As the process cartridge, for example, a process cartridge is suitably used which includes a developing unit that contains the electrostatic charge image developer according to the present exemplary embodiment.

An example of the image forming apparatus according to the present exemplary embodiment will be shown below, but the present invention is not limited thereto. Hereinafter, among the parts shown in the drawings, main parts will be described, and others will not be described.

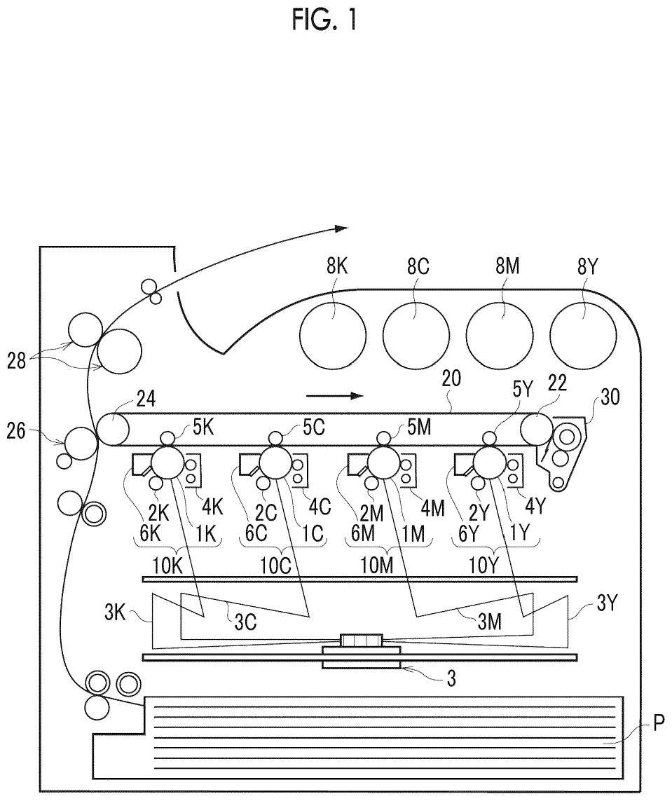

FIG. 1 is a view schematically showing the configuration of the image forming apparatus according to the present exemplary embodiment.

The image forming apparatus shown in FIG. 1 includes first to fourth image forming units 10Y, 10M, 10C, and 10K (image forming unit) adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are detachable from the image forming apparatus.

An intermediate transfer belt (an example of the intermediate transfer member) 20 passing through above the units 10Y, 10M, 10C, and 10K extends under the units. The intermediate transfer belt 20 is looped around a driving roll 22 and a support roll 24, and runs toward the fourth unit 10K from the first unit 10Y. Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the image holding surface side of the intermediate transfer belt 20.

Yellow, magenta, cyan, and black toners contained in containers of toner cartridges 8Y, 8M, 8C, and 8K are supplied to developing devices (developing units) 4Y, 4M, 4C, and 4K of the units 10Y, 10M, 10C, and 10K, respectively.

The first to fourth units 10Y, 10M, 10C, and 10K have the same configuration and operation. Therefore, in the present specification, as a representative, the first unit 10Y will be described which is placed on the upstream side of the running direction of the intermediate transfer belt and forms a yellow image.

The first unit 10Y has a photoreceptor 1Y that acts as an image holder. Around the photoreceptor 1Y, a charging roll (an example of the charging unit) 2Y that charges the surface of the photoreceptor 1Y at a predetermined potential, an exposure device (an example of the electrostatic charge image forming unit) 3 that exposes the charged surface to a laser beam 3Y based on color-separated image signals to form an electrostatic charge image, a developing device (an example of the developing unit) 4Y that develops the electrostatic charge image by supplying a charged toner to the electrostatic charge image, a primary transfer roll 5Y (an example of the primary transfer unit) that transfers the developed toner image onto the intermediate transfer belt 20, and a photoreceptor cleaning device (an example of cleaning unit) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. A bias power supply (not shown in the drawing) for applying a primary transfer bias is connected to primary transfer rolls 5Y, 5M, 5C, and 5K of each unit. Each bias power supply changes a value of the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam, the specific resistance of the portion irradiated with the laser beam changes. From the exposure device 3, the laser beam 3Y is radiated to the surface of the charged photoreceptor 1Y according to the image data for yellow transmitted from the control unit not shown in the drawing. As a result, an electrostatic charge image of the yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y is developed as a toner image by the developing device 4Y and visualized.

The developing device 4Y contains, for example, an electrostatic charge image developer that contains at least a yellow toner and a carrier. By being agitated in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the erased latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. In the first unit 10Y, the transfer bias is set, for example, to +10 μA under the control of the control unit (not shown in the drawing).

On the other hand, the residual toner on the photoreceptor 1Y is removed by a photoreceptor cleaning device 6Y and collected.

The primary transfer bias applied to the primary transfer rolls 5M, 5C, and 5K following the second unit 10M is also controlled according to the first unit.

In this manner, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt 20, and a secondary transfer roll 26 (an example of a secondary transfer unit) disposed on the image holding surface side of the intermediate transfer belt 20. On the other hand, via a supply mechanism, recording paper P (an example of recording medium) is fed at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting unit (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28 (an example of fixing unit), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

### Process Cartridge/Toner Cartridge

The process cartridge according to the present exemplary embodiment will be described.

The process cartridge according to the present exemplary embodiment includes a developing unit that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing unit and, for example, at least one member selected from other units, such as an image holder, a charging unit, an electrostatic charge image forming unit, and a transfer unit, as necessary.

An example of the process cartridge according to the present exemplary embodiment will be shown below, but the present invention is not limited thereto. Hereinafter, among the parts shown in the drawings, main parts will be described, and others will not be described.

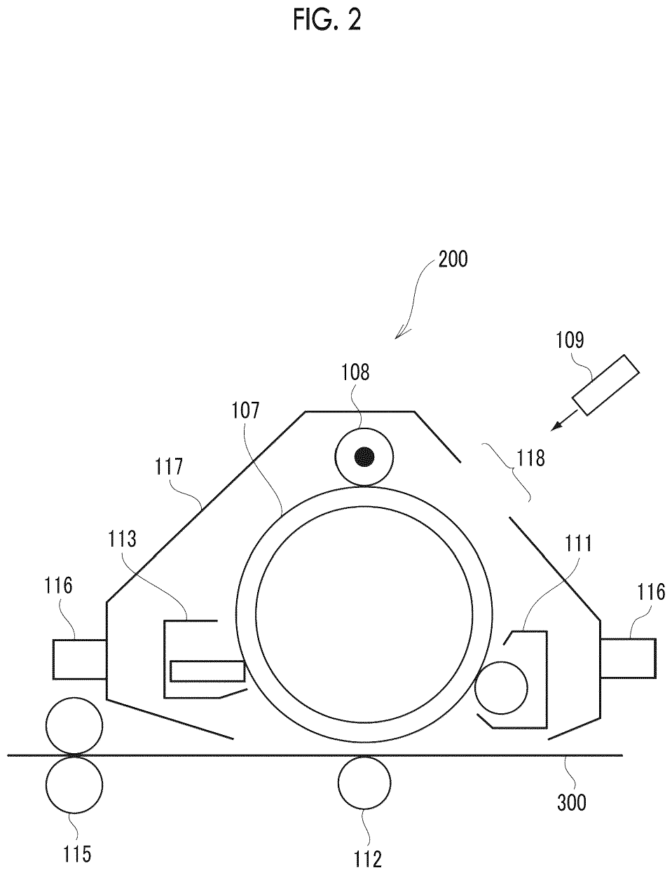

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging unit) that is provided on the periphery of the photoreceptor 107, a developing device 111 (an example of developing unit), a photoreceptor cleaning device 113 (an example of cleaning unit), that are integrally combined and held in the housing 117. The process cartridge 200 forms a cartridge in this way.

In FIG. 2, 109 indicates an exposure device (an example of electrostatic charge image forming unit), 112 indicates a transfer device (an example of transfer unit), 115 indicates a fixing device (an example of fixing unit), and 300 indicates recording paper (an example of recording medium).

Next, the toner cartridge according to the present exemplary embodiment will be described.

The toner cartridge according to the present exemplary embodiment is a toner cartridge including a container that contains the toner according to the present exemplary embodiment and is detachable from the image forming apparatus. The toner cartridge includes a container that contains a replenishing toner to be supplied to the developing unit provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In a case where the amount of the toner contained in the container of the toner cartridge is low, the toner cartridge is replaced.

### EXAMPLES

Hereinafter, exemplary embodiments of the invention will be specifically described based on examples. However, the exemplary embodiments of the invention are not limited to the examples.

In the following description, unless otherwise specified, “parts” and “%” are based on mass.

In the following description, the synthesis, the production, the treatment, the measurement, and the like are carried out at room temperature (25° C.±3° C.) unless otherwise specified.

### Production of Amorphous Polyester Resin

### Production of Amorphous Polyester Resin (A)

The following materials are prepared.
Terephthalic acid: 30 parts by mole
Fumaric acid: 70 parts by mole
Ethylene oxide adduct of bisphenol A: 5 parts by mole
Propylene oxide adduct of bisphenol A: 95 parts by mole

The above-described materials are charged into a flask equipped with an agitation device, a nitrogen introduction pipe, a temperature sensor, and a rectification column, the temperature of the reaction solution is raised to 220° C. over 1 hour, and 1 part of titanium tetraethoxide with respect to 100 parts of the above-described materials is added thereto. The temperature of the reaction solution is raised to 230° C. over 30 minutes while distilling off water to be generated, and the dehydration condensation reaction is continued for 1 hour while maintaining the temperature of the reaction solution at 230° C. Thereafter, the temperature of the reaction product is lowered to room temperature. In this manner, an amorphous polyester resin (A) having an acid value of 15.0 mgKOH/g, a weight-average molecular weight of 18,000, and a glass transition temperature of 60° C. is obtained.

### Production of Amorphous Polyester Resin (B)

The following materials are prepared.
Terephthalic acid: 25 parts by mole
Fumaric acid: 75 parts by mole
Ethylene oxide adduct of bisphenol A: 5 parts by mole
Propylene oxide adduct of bisphenol A: 95 parts by mole

The above-described materials are charged into a flask equipped with an agitation device, a nitrogen introduction pipe, a temperature sensor, and a rectification column, the temperature of the reaction solution is raised to 220° C. over 1 hour, and 1 part of titanium tetraethoxide with respect to 100 parts of the above-described materials is added thereto. The temperature of the reaction solution is raised to 230° C. over 30 minutes while distilling off water to be generated, and the dehydration condensation reaction is continued for 1 hour while maintaining the temperature of the reaction solution at 230° C. Thereafter, the temperature of the reaction product is lowered to room temperature. In this manner, an amorphous polyester resin (B) having an acid value of 0.5 mgKOH/g, a weight-average molecular weight of 18,000, and a glass transition temperature of 60° C. is obtained.

### Production of Amorphous Polyester Resin (C)

The following materials are prepared.
Terephthalic acid: 27 parts by mole
Fumaric acid: 73 parts by mole
Ethylene oxide adduct of bisphenol A: 5 parts by mole
Propylene oxide adduct of bisphenol A: 95 parts by mole

The above-described materials are charged into a flask equipped with an agitation device, a nitrogen introduction pipe, a temperature sensor, and a rectification column, the temperature of the reaction solution is raised to 220° C. over 1 hour, and 1 part of titanium tetraethoxide with respect to 100 parts of the above-described materials is added thereto. The temperature of the reaction solution is raised to 230° C. over 30 minutes while distilling off water to be generated, and the dehydration condensation reaction is continued for 1 hour while maintaining the temperature of the reaction solution at 230° C. Thereafter, the temperature of the reaction product is lowered to room temperature. In this manner, an amorphous polyester resin (C) having an acid value of 1.0 mgKOH/g, a weight-average molecular weight of 18,000, and a glass transition temperature of 60° C. is obtained.

### Production of Amorphous Polyester Resin (D)

The following materials are prepared.
Terephthalic acid: 37.5 parts by mole
Fumaric acid: 62.5 parts by mole
Ethylene oxide adduct of bisphenol A: 5 parts by mole
Propylene oxide adduct of bisphenol A: 95 parts by mole

The above-described materials are charged into a flask equipped with an agitation device, a nitrogen introduction pipe, a temperature sensor, and a rectification column, the temperature of the reaction solution is raised to 220° C. over 1 hour, and 1 part of titanium tetraethoxide with respect to 100 parts of the above-described materials is added thereto. The temperature of the reaction solution is raised to 230° C. over 30 minutes while distilling off water to be generated, and the dehydration condensation reaction is continued for 1 hour while maintaining the temperature of the reaction solution at 230° C. Thereafter, the temperature of the reaction product is lowered to room temperature. In this manner, an amorphous polyester resin (D) having an acid value of 50.0 mgKOH/g, a weight-average molecular weight of 18,000, and a glass transition temperature of 60° C. is obtained.

### Production of Amorphous Polyester Resin (E)

The following materials are prepared.
Terephthalic acid: 42 parts by mole
Fumaric acid: 58 parts by mole
Ethylene oxide adduct of bisphenol A: 5 parts by mole
Propylene oxide adduct of bisphenol A: 95 parts by mole

The above-described materials are charged into a flask equipped with an agitation device, a nitrogen introduction pipe, a temperature sensor, and a rectification column, the temperature of the reaction solution is raised to 220° C. over 1 hour, and 1 part of titanium tetraethoxide with respect to 100 parts of the above-described materials is added thereto. The temperature of the reaction solution is raised to 230° C. over 30 minutes while distilling off water to be generated, and the dehydration condensation reaction is continued for 1 hour while maintaining the temperature of the reaction solution at 230° C. Thereafter, the temperature of the reaction product is lowered to room temperature. In this manner, an amorphous polyester resin (E) having an acid value of 70.0 mgKOH/g, a weight-average molecular weight of 18,000, and a glass transition temperature of 60° C. is obtained.

### Production of Dispersion of Pigment-containing Polyester Resin Particles

### Production of Dispersion (P1) of Pigment-containing Polyester Resin Particles

The following materials are prepared.
Amorphous polyester resin (A): 160 parts
Carbon black (product name: Regal 330; Cabot Corporation): 40 parts
Basic compound: 50% sodium hydroxide aqueous solution: 0.2 parts
Surfactant: 48.5% sodium dodecyl diphenyl ether disulfonate aqueous solution (product name: ELEMINOL MON-7, Sanyo Chemical Industries, Ltd.): 4.1 parts
Deionized water (1): deionized water at a temperature of 90° C.: 150 parts
Deionized water (2): deionized water at a temperature of 90° C.: 150 parts
Deionized water (3): deionized water at a temperature of 90° C.: 150 parts

A biaxial kneading extruder (model number: TEM26SS, Shibaura Machine CO., LTD.) is prepared. A barrel of the biaxial kneading extruder used in the present example is formed by connecting a plurality of barrel blocks.

### Mixing Step

A barrel temperature of the biaxial kneading extruder is set to 95° C., and a screw rotation speed is set to 400 rpm. The amorphous polyester resin (A) and the carbon black are charged into a raw material inlet of the biaxial kneading extruder, and kneaded to discharge a material to be treated once. The material to be treated and a 50% sodium hydroxide aqueous solution are charged into a raw material inlet of the biaxial kneading extruder, a surfactant is charged from a fourth block barrel, and all of the components are kneaded to form a mixture containing a polyester resin, a pigment, a basic compound, and a surfactant.

### Emulsification Step

Furthermore, while operating the biaxial kneading extruder such that an average supply amount of the mixture is 12 kg/h, the deionized water (1) is charged from a fifth block barrel, the deionized water (2) is charged from a seventh block barrel, and the deionized water (3) is charged from a ninth block barrel, so that the mixture is emulsified to obtain a dispersion (P1) of the pigment-containing polyester resin particles. A concentration of solid contents of the dispersion (P1) of the pigment-containing polyester resin particles is 25%.

A particle size distribution of the particles in the dispersion (P1) of the pigment-containing polyester resin particles is measured with a laser diffraction-type particle size distribution analyzer (model number: LS13-320, Beckman Coulter, Inc.). A volume-average particle size of the particles in the dispersion (P1) of the pigment-containing polyester resin particles is 200 nm.

### Production of Dispersions (P2) to (P10) and (P12) to (P16) of Pigment-Containing Polyester Resin Particles

Each dispersion of the pigment-containing polyester resin particles is produced in the same manner as in the production of the dispersion (P1) of the pigment-containing polyester resin particles, except that the operation conditions of the biaxial kneading extruder or the type of the amorphous polyester resin is changed as shown in Table 1, and the amount of carbon black used is adjusted as necessary.

### Production of Dispersion (P11) of Pigment-containing Polyester Resin Particles

The following materials are prepared.
Organic solvent (1): ethyl acetate: 40 parts
Organic solvent (2): 2-butanol: 25 parts
Amorphous polyester resin (A): 160 parts
Carbon black (product name: Regal 330; Cabot Corporation): 40 parts
Basic compound: 10% ammonia water: equivalent of 3 times in terms of molar ratio with respect to the acid value of the polyester resin
Deionized water (4): deionized water at a temperature of 40° C.: 400 parts
Surfactant: 48.5% sodium dodecyl diphenyl ether disulfonate aqueous solution (product name: ELEMINOL MON-7, Sanyo Chemical Industries, Ltd.): 1.0 part

### Dissolving Step

The organic solvent (1) and the organic solvent (2) are charged into an agitated vessel provided with an agitation device, a condenser, a heater, and a thermometer to prepare a mixed solvent. The temperature in the agitated vessel is kept at 40° C., and the amorphous polyester resin (A) is charged into the agitated vessel and dissolved while agitating, and carbon black is gradually charged into the agitated vessel and dispersed.

### Emulsification Step

The temperature in the agitated vessel is maintained, and the agitation is continued while the basic compound is charged thereto and agitated for 30 minutes. The inside of the agitated vessel is replaced with dry nitrogen, and while agitating kept at a temperature of 40° C., the deionized water (4) is added dropwise thereto at a rate of 2 parts/min to emulsify the contents. After the dropwise addition, the heating of the agitated vessel is stopped and the temperature of the emulsion is lowered to room temperature, and then the emulsion is bubbled with dry nitrogen for 48 hours to remove the organic solvent from the emulsion. Next, the surfactant is added thereto, deionized water is added to adjust the concentration of solid contents to 25%, thereby obtaining a dispersion (P11) of the pigment-containing polyester resin particles. A volume-average particle size of the particles in the dispersion (P11) of the pigment-containing polyester resin particles is 200 nm.

### Production of Dispersion (SA1) of Pigment-Containing Styrene Acrylic Resin Particles

The following materials are prepared.
Deionized water: 300 parts
Sodium dodecylbenzenesulfonate: 3 parts
Styrene: 60 parts
2-Ethylhexyl methacrylate: 15 parts
Ethylene glycol dimethacrylate: 5 parts
Polymerization initiator: t-butyl peroxy-2-ethylhexanoate 1 part

Deionized water and sodium dodecylbenzenesulfonate are charged into an agitated vessel and agitated. The monomers and polymerization initiator described above are charged thereto and agitated to obtain a monomer solution.

The following materials are prepared.
Deionized water: 180 parts
Sodium dodecylbenzenesulfonate: 1.8 parts
Carbon black (product name: Regal 330; Cabot Corporation): 20 parts

Deionized water and sodium dodecylbenzenesulfonate are charged into a beads mill and mixed, carbon black is further charged into the beads mill, and the mixture is dispersed to obtain a pigment dispersion.

The monomer solution and the pigment dispersion are charged into an agitated vessel, and the mixture is agitated at a temperature of 30° C. for 20 minutes, and then the temperature is raised to 90° C. and maintained for 3 hours while agitating. Next, the liquid temperature is lowered to room temperature, and the solid content is filtered off and sufficiently washed with deionized water. The solid matter after the washing is dispersed in deionized water to which a surfactant (sodium dodecyl diphenyl ether disulfonate) has been added, thereby obtaining a dispersion (SA1) of pigment-containing styrene acrylic resin particles, having a concentration of solid contents of 25%. A volume-average particle size of the particles in the dispersion (SA1) of the pigment-containing styrene acrylic resin particles is 200 nm.

### Production of Dispersion (1) of Amorphous Polyester Resin Particles

The following materials are prepared.
Terephthalic acid: 30 parts by mole
Fumaric acid: 70 parts by mole
Ethylene oxide adduct of bisphenol A: 5 parts by mole
Propylene oxide adduct of bisphenol A: 95 parts by mole

The above-described materials are charged into a flask equipped with an agitation device, a nitrogen introduction pipe, a temperature sensor, and a rectification column, the temperature of the reaction solution is raised to 220° C. over 1 hour, and 1 part of titanium tetraethoxide with respect to 100 parts of the above-described materials is added thereto. The temperature of the reaction solution is raised to 230° C. over 30 minutes while distilling off water to be generated, and the dehydration condensation reaction is continued for 1 hour while maintaining the temperature of the reaction solution at 230° C. Thereafter, the temperature of the reaction product is lowered to room temperature. In this manner, an amorphous polyester resin having a weight-average molecular weight of 18,000 and a glass transition temperature of 60° C. is obtained.

40 parts of ethyl acetate and 25 parts of 2-butanol are charged into a container provided with a temperature control unit and a nitrogen replacement unit to prepare a mixed solvent. 100 parts of the amorphous polyester resin is gradually added to the mixed solvent and dissolved, and 10% ammonia aqueous solution (equivalent of 3 times in terms of molar ratio with respect to the acid value of the resin) is added thereto and agitated for 30 minutes. Next, the inside of the container is replaced with dry nitrogen, the temperature of the reaction solution is kept at 40° C., and 400 parts of deionized water is added dropwise to the reaction solution at a rate of 2 parts/min while agitating the reaction solution to emulsify. After the dropwise addition of the deionized water is completed, the temperature of the emulsion is lowered to room temperature, and bubbling with dry nitrogen is performed for 48 hours while agitating the emulsion to reduce the total amount of the ethyl acetate and the 2-butanol to 1,000 ppm or less. Deionized water is added to the emulsion to adjust a concentration of solid contents to 20%. In this manner, a dispersion (1) of amorphous polyester resin particles is obtained. A volume-average particle size of the particles in the dispersion (1) of amorphous polyester resin particles is 180 nm.

### Production of Dispersion (1) of Release Agent Particles

The following materials are prepared.
Paraffin wax (HNP-9, NIPPON SEIRO CO., LTD.): 100 parts
Deionized water: 350 parts
Anionic surfactant (product name: NEOGEN RK, DKS Co. Ltd., aqueous solution with a concentration of 20%): 1 part

The above-described materials are mixed with each other, heated to 100° C., and then subjected to a dispersion treatment using a homogenizer (ULTRA-TURRAX T50, IKA) and a pressure jet-type homogenizer (Manton-Gaulin high-pressure homogenizer, Gaulin Corporation). At a point in time when the volume-average particle size reaches 200 nm, the dispersed resultant is collected, thereby obtaining a dispersion (1) of release agent particles, having a concentration of solid contents of 20%.

### Example 1

### Manufacturing of Toner Particles

The following materials are prepared.
Deionized water: 200 parts
Dispersion (1) of amorphous polyester resin particles: 80 parts
Dispersion (P1) of pigment-containing polyester resin particles: 3.7 parts
Dispersion (1) of release agent particles: 8.0 parts
Anionic surfactant (product name: NEOGEN RK, DKS Co. Ltd., aqueous solution with a concentration of 20%): 1.1 parts

### First Aggregation Step

The above-described materials are charged into a round stainless flask, 0.1 N nitric acid is added thereto to adjust the pH to 3.5, and 30 parts of a nitric acid aqueous solution of polyaluminum chloride with a concentration of 10% is added thereto. The liquid temperature is adjusted to 30° C. using an oil bath, the mixture is dispersed using a homogenizer (product name: ULTRA-TURRAX T50, IKA), and the liquid temperature is raised to 45° C. and maintained for 30 minutes to form first aggregated particles.

### Second Aggregation Step

20 parts of the dispersion (1) of amorphous polyester resin particles is added to the dispersion containing the first aggregated particles, while keeping the liquid temperature of the dispersion containing the first aggregated particles at 45° C., and the mixture is held for 60 minutes to form second aggregated particles.

### Coalescence Step

0.1N sodium hydroxide aqueous solution is added to the dispersion containing the second aggregated particles to adjust the pH to 8.5, and the liquid temperature is raised to 84° C. and maintained for 150 minutes. Next, the mixture is cooled to 20° C. at a rate of 20° C./min, and then the solid content is filtered off, washed with deionized water, and dried. The dried matter is sieved to obtain toner particles (1). A volume-average particle size of the toner particles (1) is 6.0 μm.

### Production of Externally Added Toner

1.5 parts of hydrophobic silica particles (product number: RY50, NIPPON AEROSIL CO., LTD.) and 1.0 part of hydrophobic titanium oxide (product number: T805, NIPPON AEROSIL CO., LTD.) are added to 100 parts of the toner particles (1), and the mixture is mixed using a sample mill at 10,000 rpm for 30 seconds. Thereafter, the mixture is sieved using a vibration sieve having an opening size of 45 μm, thereby obtaining an externally added toner.

### Production of Developer

8 parts of the externally added toner and 92 parts of a carrier (1) shown below are charged into a V blender and agitated for 20 minutes. Thereafter, the mixture is sieved using a sieve having an opening size of 212 μm, thereby obtaining a developer.

### Production of Carrier (1)

14 parts of toluene, 5 parts of polymethyl methacrylate (weight-average molecular weight: 75,000), and 0.2 parts of carbon black (product number: VXC-72, Cabot Corporation) are charged into a sand mill and dispersed to prepare a dispersion. The dispersion and 100 parts of ferrite particles (average particle size: 35 μm) are placed in a vacuum deaeration kneader, and while agitating, the mixture is dried under reduced pressure to obtain the carrier (1).

### Examples 2 to 15 and Comparative Examples 1 and 2

Each of the toner particles, the externally added toner, and the developer is produced in the same manner as in Example 1, except that the type of the dispersion of the pigment-containing resin particles is changed as shown in Table 1.

### Performance Evaluation

### Proportion of Coarse Particles

Sieving of the dispersions (P1) to (P16) of pigment-containing polyester resin particles and the dispersion (SA1) of pigment-containing styrene acrylic resin particles, with an amount of solid content of 100 g, is performed using a standard sieve having an opening size of 20 μm. A mass proportion of an amount of solid content that does not pass through the sieve is classified as follows. G1 to G3 are in acceptable ranges.
G1: less than 0.5%
G1.5: 0.5% or more and less than 1%
G2: 1% or more and less than 1.5%
G2.5: 1.5% or more and less than 2%
G3: 2% or more and less than 5%
G4: 5% or more

### Low-Temperature Fixability

The following operation and image formation are performed in an environment of a temperature of 28° C. and a relative humidity of 85%.

Premier TCF (basis weight: 80 g/m², A4 size, FUJIFILM Business Innovation Corp.) is used as a recording paper. The Premier TCF is paper having a relatively rough surface, and is paper in which heat is unlikely to be uniformly transmitted to a toner on the paper and low-temperature fixing of the toner is relatively difficult.

The developer is filled in a developing device of a modified machine of an image forming apparatus ApeosPort-V C7775 (FUJIFILM Business Innovation Corp.). A temperature of a fixing machine is set to 140° C., and an amount of the toner adhesion to the paper is set to 1.0 mg/cm².

A black solid image having an image density of 100% and a black halftone image having an image density of 30% are formed on each of a leading end part and a trailing end part of the paper. 1,000 sheets are output, 1,000 black solid images and black halftone images are visually observed, and the presence or absence of white spots is classified as follows. A to C are in acceptable ranges.
A: white spots are not observed.
B: white spots are slightly observed.
C: white spots are slightly observed.
D: white spots are observed to an extent that is not acceptable.

### Image Unevenness

The developer is filled in a developing device of a modified machine of an image forming apparatus ApeosPort-V C7775 (FUJIFILM Business Innovation Corp.). The temperature and relative humidity in the image forming apparatus are adjusted to 30° C. and 90% RH, and the developer is allowed to stand for 3 days.

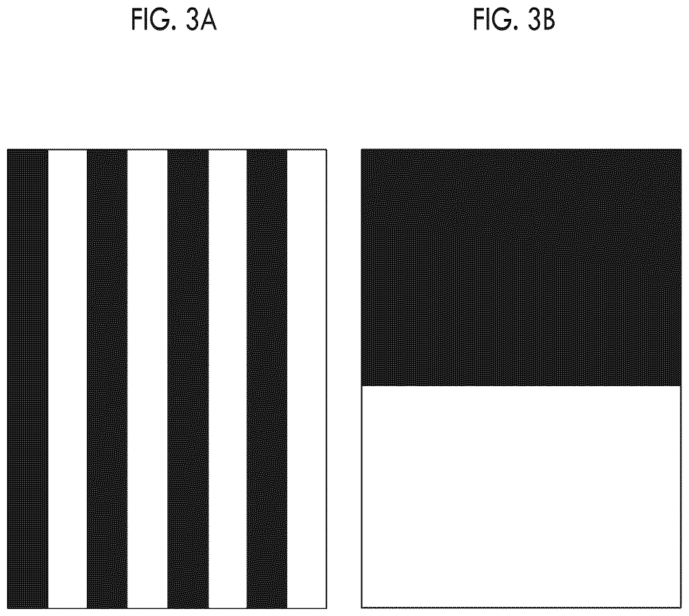

After leaving the developer to stand for 3 days, 20,000 black images (area coverage: 50%, density of image area: 100%) shown in FIG. 3A are immediately output to A3-size plain paper. Subsequently, one black image (area coverage: 50%, density of image area: 100%) shown in FIG. 3B is output to A3-size plain paper.

The density of the black image of FIG. 3B is measured at 10 places using a densitometer (product name: X-Rite 938, X-Rite, Inc.). A difference between the maximum value and the minimum value of the image densities at the 10 places is calculated and classified as follows. A and B are in acceptable ranges.
A: difference in image density is 0.20 or less.
B: difference in image density is more than 0.20 and 0.30 or less.
C: difference in image density is more than 0.30 and 0.35 or less.
D: difference in image density is more than 0.35.

TABLE 1

| | | Pigment-containing resin particles | | | | | | | |
|---|---|---|---|---|---|---|---|---|---|
| | | | | Operation conditions | | | | | |
| | | | | | | Supply | | | |
| | | Name of | | Barrel | Rotation | amount of | | Acid value | Content of |
| | | dispersion | Emulsification method | temperature | speed | mixture | Type of resin | of resin | pigment |
| | | — | — | ° C. | rpm | kg/h | — | mgKOH/g | % by mass |
| Comparative | 1 | (P16) | Solventless emulsification | 95 | 100 | 20 | Polyester (A) | 15.0 | 20 |
| Example | 2 | (SA1) | — | — | | | Styrene acrylic | 15.0 | 20 |
| Example | 1 | (P1) | Solventless emulsification | 95 | 400 | 12 | Polyester (A) | 15.0 | 20 |
| | 2 | (P2) | Solventless emulsification | 95 | 400 | 12 | Polyester (A) | 15.0 | 10 |
| | 3 | (P3) | Solventless emulsification | 95 | 400 | 12 | Polyester (A) | 15.0 | 60 |
| | 4 | (P4) | Solventless emulsification | 95 | 400 | 12 | Polyester (A) | 15.0 | 70 |
| | 5 | (P5) | Solventless emulsification | 95 | 400 | 8 | Polyester (A) | 15.0 | 20 |
| | 6 | (P6) | Solventless emulsification | 95 | 400 | 20 | Polyester (A) | 15.0 | 20 |
| | 7 | (P7) | Solventless emulsification | 95 | 500 | 10 | Polyester (A) | 15.0 | 20 |
| | 8 | (P8) | Solventless emulsification | 95 | 500 | 12 | Polyester (A) | 15.0 | 20 |
| | 9 | (P9) | Solventless emulsification | 95 | 300 | 12 | Polyester (A) | 15.0 | 20 |
| | 10 | (P10) | Solventless emulsification | 95 | 300 | 15 | Polyester (A) | 15.0 | 20 |
| | 11 | (P11) | Solvent emulsification | — | | | Polyester (A) | 15.0 | 20 |
| | 12 | (P12) | Solventless emulsification | 95 | 400 | 12 | Polyester (B) | 0.5 | 20 |
| | 13 | (P13) | Solventless emulsification | 95 | 400 | 12 | Polyester (C) | 1.0 | 20 |
| | 14 | (P14) | Solventless emulsification | 95 | 400 | 12 | Polyester (D) | 50.0 | 20 |
| | 15 | (P15) | Solventless emulsification | 95 | 400 | 12 | Polyester (E) | 70.0 | 20 |

| | | Pigment-containing resin particles | | | | Toner particles | | |
|---|---|---|---|---|---|---|---|---|
| | | | | Exposure | | Pigment having | | |
| | | | Volume- | and | | maximum | Performance of toner | |
| | | Average | average | inscription | Proportion | Feret diameter | Low- | |
| | | size of | particle | of | of coarse | of 250 nm | temperature | Image |
| | | pigment | size | pigment | particles | or more | fixability | unevenness |
| | | nm | nm | — | — | % by number | — | — |
| Comparative | 1 | 180 | 200 | Y | G4 | 15 | C | C |
| Example | 2 | 100 | 200 | N | G1 | 10 | D | C |
| Example | 1 | 100 | 200 | N | G1 | 10 | A | A |
| | 2 | 100 | 200 | N | G1 | 10 | A | B |
| | 3 | 100 | 200 | N | G2 | 15 | B | B |
| | 4 | 100 | 200 | N | G2.5 | 15 | B | B |
| | 5 | 10 | 200 | N | G1 | 10 | A | A |
| | 6 | 100 | 200 | N | G1 | 20 | A | B |
| | 7 | 30 | 40 | N | G3 | 5 | B | A |
| | 8 | 30 | 50 | N | G2 | 5 | B | A |
| | 9 | 120 | 500 | N | G2 | 15 | B | B |
| | 10 | 120 | 600 | N | G3 | 18 | B | B |
| | 11 | 100 | 200 | N | G1 | 10 | A | A |
| | 12 | 100 | 200 | N | G2 | 10 | B | B |
| | 13 | 100 | 200 | N | G1.5 | 10 | B | A |
| | 14 | 100 | 200 | N | G1.5 | 10 | B | A |
| | 15 | 100 | 200 | N | G2 | 10 | B | B |

The pigment-containing polyester resin particles, the production method of pigment-containing polyester resin particles, the manufacturing method of an electrostatic charge image developing toner, the electrostatic charge image developing toner, the electrostatic charge image developer, the toner cartridge, the process cartridge, the image forming apparatus, and the image forming method according to the present disclosure include the following aspects.
(((1)

Pigment-containing polyester resin particles comprising:
a polyester resin; and
a pigment,
wherein the pigment is not exposed on a surface of the pigment-containing polyester resin particles and is not inscribed in a contour of the pigment-containing polyester resin particles.
(((2)))

The pigment-containing polyester resin particles according to (((1))),
wherein a volume-average particle size is 50 nm or more and 500 nm or less.
(((3)))

The pigment-containing polyester resin particles according to (((1))) or (((2))),
wherein a content of the pigment is 10% by mass or more and 60% by mass or less.
(((4)))

The pigment-containing polyester resin particles according to any one of (((1))) to (((3))),
wherein an average size of the pigment is 10 nm or more and 400 nm or less.
(((5)))

The pigment-containing polyester resin particles according to any one of (((1))) to (((4))),
wherein an acid value of the polyester resin is 1 mgKOH/g or more and 50 mgKOH/g or less.
(((6))

A production method of the pigment-containing polyester resin particles according to any one of (((1))) to (((5))), the method comprising:
mixing a polyester resin, a pigment, a basic compound, and a surfactant by applying heat and a shear force to obtain a mixture in which the pigment is dispersed in a melted polyester resin; and
adding an aqueous medium to the mixture while applying a shear force to the mixture to perform emulsification.
(((7)))

A production method of the pigment-containing polyester resin particles according to any one of (((1))) to (((5))), the method comprising:
mixing a polyester resin, a pigment, and an organic solvent by applying heat and a shear force to obtain a mixture in which the pigment is dispersed in a dissolved polyester resin; and
adding a basic compound to the mixture, and adding an aqueous medium to the mixture while applying a shear force to the mixture to perform emulsification.
(((8)))

A manufacturing method of an electrostatic charge image developing toner, the method comprising:
aggregating the pigment-containing polyester resin particles according to any one of (((1))) to (((5))) in a dispersion containing the pigment-containing polyester resin particles to form aggregated particles; and
heating the dispersion containing the aggregated particles for coalescing the aggregated particles together to form toner particles.
(((9)))

An electrostatic charge image developing toner comprising:
toner particles containing a polyester resin and a pigment,
wherein, in the toner particles, a number proportion of a pigment having a maximum Feret diameter of 250 nm or more is 20% by number or less.
(((10)))

An electrostatic charge image developer comprising:
the electrostatic charge image developing toner according to (((9))).
(((11)))

A toner cartridge comprising:
a container that contains the electrostatic charge image developing toner according to (((9))),
wherein the toner cartridge is detachable from an image forming apparatus.
(((12)))

A process cartridge comprising:
a developing unit that contains the electrostatic charge image developer according to (((10))) and develops an electrostatic charge image formed on a surface of an image holder as a toner image using the electrostatic charge image developer,
wherein the process cartridge is detachable from an image forming apparatus.
(((13)))

An image forming apparatus comprising:
an image holder;
a charging unit that charges a surface of the image holder;
an electrostatic charge image forming unit that forms an electrostatic charge image on the charged surface of the image holder;
a developing unit that contains the electrostatic charge image developer according to (((10))) and develops the electrostatic charge image formed on the surface of the image holder as a toner image using the electrostatic charge image developer;
a transfer unit that transfers the toner image formed on the surface of the image holder to a surface of a recording medium; and
a fixing unit that fixes the toner image transferred to the surface of the recording medium.
(((14)))

An image forming method comprising:
charging a surface of an image holder;
forming an electrostatic charge image on the charged surface of the image holder;
developing the electrostatic charge image formed on the surface of the image holder as a toner image using the electrostatic charge image developer according to (((10)));
transferring the toner image formed on the surface of the image holder to a surface of a recording medium; and
fixing the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. Pigment-containing polyester resin particles comprising:
a polyester resin; and
a pigment,
wherein the pigment is not exposed on a surface of the pigment-containing polyester resin particles and is not inscribed in a contour of the pigment-containing polyester resin particles.

2. The pigment-containing polyester resin particles according to claim 1,
wherein a volume-average particle size is 50 nm or more and 500 nm or less.

3. The pigment-containing polyester resin particles according to claim 1,
wherein a content of the pigment is 10% by mass or more and 60% by mass or less.

4. The pigment-containing polyester resin particles according to claim 1,
wherein an average size of the pigment is 10 nm or more and 400 nm or less.

5. The pigment-containing polyester resin particles according to claim 1,
wherein an acid value of the polyester resin is 1 mgKOH/g or more and 50 mgKOH/g or less.

6. A production method of the pigment-containing polyester resin particles according to claim 1, the method comprising:
mixing a polyester resin, a pigment, a basic compound, and a surfactant by applying heat and a shear force to obtain a mixture in which the pigment is dispersed in a melted polyester resin; and
adding an aqueous medium to the mixture while applying a shear force to the mixture to perform emulsification.

7. A production method of the pigment-containing polyester resin particles according to claim 2, the method comprising:
mixing a polyester resin, a pigment, a basic compound, and a surfactant by applying heat and a shear force to obtain a mixture in which the pigment is dispersed in a melted polyester resin; and
adding an aqueous medium to the mixture while applying a shear force to the mixture to perform emulsification.

8. A production method of the pigment-containing polyester resin particles according to claim 3, the method comprising:
mixing a polyester resin, a pigment, a basic compound, and a surfactant by applying heat and a shear force to obtain a mixture in which the pigment is dispersed in a melted polyester resin; and
adding an aqueous medium to the mixture while applying a shear force to the mixture to perform emulsification.

9. A production method of the pigment-containing polyester resin particles according to claim 4, the method comprising:
mixing a polyester resin, a pigment, a basic compound, and a surfactant by applying heat and a shear force to obtain a mixture in which the pigment is dispersed in a melted polyester resin; and
adding an aqueous medium to the mixture while applying a shear force to the mixture to perform emulsification.

10. A production method of the pigment-containing polyester resin particles according to claim 5, the method comprising:
mixing a polyester resin, a pigment, a basic compound, and a surfactant by applying heat and a shear force to obtain a mixture in which the pigment is dispersed in a melted polyester resin; and
adding an aqueous medium to the mixture while applying a shear force to the mixture to perform emulsification.

11. A production method of the pigment-containing polyester resin particles according to claim 1, the method comprising:
mixing a polyester resin, a pigment, and an organic solvent by applying heat and a shear force to obtain a mixture in which the pigment is dispersed in a dissolved polyester resin; and
adding a basic compound to the mixture, and adding an aqueous medium to the mixture while applying a shear force to the mixture to perform emulsification.

12. A production method of the pigment-containing polyester resin particles according to claim 2, the method comprising:
mixing a polyester resin, a pigment, and an organic solvent by applying heat and a shear force to obtain a mixture in which the pigment is dispersed in a dissolved polyester resin; and
adding a basic compound to the mixture, and adding an aqueous medium to the mixture while applying a shear force to the mixture to perform emulsification.

13. A production method of the pigment-containing polyester resin particles according to claim 3, the method comprising:
mixing a polyester resin, a pigment, and an organic solvent by applying heat and a shear force to obtain a mixture in which the pigment is dispersed in a dissolved polyester resin; and
adding a basic compound to the mixture, and adding an aqueous medium to the mixture while applying a shear force to the mixture to perform emulsification.

14. A manufacturing method of an electrostatic charge image developing toner, the method comprising:
aggregating the pigment-containing polyester resin particles according to claim 1 in a dispersion containing the pigment-containing polyester resin particles to form aggregated particles; and
heating the dispersion containing the aggregated particles for coalescing the aggregated particles together to form toner particles.

15. An electrostatic charge image developing toner comprising:
toner particles containing a polyester resin and a pigment,
wherein, in the toner particles, a number proportion of a pigment having a maximum Feret diameter of 250 nm or more is 20% by number or less.

16. An electrostatic charge image developer comprising:
the electrostatic charge image developing toner according to claim 15.

17. A toner cartridge comprising:
a container that contains the electrostatic charge image developing toner according to claim 15,
wherein the toner cartridge is detachable from an image forming apparatus.

18. A process cartridge comprising:
a developing unit that contains the electrostatic charge image developer according to claim 16 and develops an electrostatic charge image formed on a surface of an image holder as a toner image using the electrostatic charge image developer,
wherein the process cartridge is detachable from an image forming apparatus.

19. An image forming apparatus comprising:
an image holder;
a charging unit that charges a surface of the image holder;
an electrostatic charge image forming unit that forms an electrostatic charge image on the charged surface of the image holder;
a developing unit that contains the electrostatic charge image developer according to claim 16 and develops the electrostatic charge image formed on the surface of the image holder as a toner image using the electrostatic charge image developer;
a transfer unit that transfers the toner image formed on the surface of the image holder to a surface of a recording medium; and
a fixing unit that fixes the toner image transferred to the surface of the recording medium.

20. An image forming method comprising:
charging a surface of an image holder;
forming an electrostatic charge image on the charged surface of the image holder;
developing the electrostatic charge image formed on the surface of the image holder as a toner image using the electrostatic charge image developer according to claim 16;
transferring the toner image formed on the surface of the image holder to a surface of a recording medium; and
fixing the toner image transferred to the surface of the recording medium.
